(19) United States
(12) Patent Application Publication
(10) Pub. No.: US 2009/0122059 A1
(43) Pub. Date: May 14, 2009

(54) PART IDENTIFICATION IMAGE GENERATION DEVICE, PART IDENTIFICATION IMAGE GENERATION METHOD, PART IDENTIFICATION IMAGE DISPLAY DEVICE, PART IDENTIFICATION IMAGE DISPLAY METHOD, AND RECORDING MEDIUM

(76) Inventors: Takashi Katooka, Kanagawa (JP); Masanori Harada, Tokyo (JP); Naoyuki Satoh, Kanagawa (JP)

Correspondence Address: DICKSTEIN SHAPIRO LLP, 1825 EYE STREET NW, Washington, DC, 20006-5403, US

(21) Appl. No.: 12/257,823

(22) Filed: Oct. 24, 2008

(30) Foreign Application Priority Data
Nov. 9, 2007 (JP) 2007-291644

(51) Int. Cl. G06T 17/00

(52) U.S. Cl. 345/420

(57) ABSTRACT

A disclosed part identification image generation device includes a model management unit that manages a 3D model; a model region calculation unit that projects the shape of the 3D model and computes model region information; a part region calculation unit that projects the shape of a part of the 3D model and computes part region information; an image data processing unit that clips an image of the 3D model from a projection image of the 3D model to generate an entire model image, clips an image of the part from the projection image of the 3D model to generate a part highlight image, and computes part positional information; a part resolution ratio calculation unit that calculates part resolution ratio; and an image data management unit that manages the entire model image, the part highlight image, the part positional information, and the part resolution ratio as part catalog image data.

### BACKGROUND OF THE INVENTION

1. Field of the Invention

The present invention relates to a part identification image generation device, a part identification image generation method, a part identification image display device, a part identification image display method, and a recording medium for use when generating a part catalog.

2. Description of the Related Art

In recent years, various image content has been widely used owing to the improvement in the performance of computers and development in multimedia technology. In industrial product manufacturing industries, companies have become able to create an image of their own product model and use the image as content of electronic media such as part catalogs and service manuals. Many industrial products such as mechanical products and electrical products are composed of plural parts. Therefore, when using an image of a product model, it is often necessary to identify parts of the product in the image.

In such a case, an image is shown in an exploded view of the product model in which each part is shown along with an identifier written in characters, such as a serial number, so that the parts are identified in the image.

With this approach, however, it is difficult to visualize the assembled product and is therefore difficult to identify the parts mounted on a certain portion of the product.

In view of this problem, Japanese Patent Laid-Open Publication No. 09-190456 discloses a method that specifies a 3D closed space in a CAD system, in which information of a three-dimensional (3D) product model is loaded, and extracts parts of the product model located in the specified closed space. However, this method is applicable to CAD systems only and cannot achieve part identification in general two-dimensional images.

The Applicant of this application has proposed a part identification image processor that clips a part image from a model image and highlights the clipped part image (see Japanese Patent Laid-Open Publication No. 2006-242561).

However, it has been found that, when the highlighted clipped part image is small compared to the image of the entire model, the shape of the part is not clear.

That is, when the highlighted clipped part image is small compared to the image of the entire model (the entire model image), the shape of the part is not clearly displayed.

If the resolution of the original image is low, the quality of the highlighted part image (the part highlight image) is reduced when enlarged. To avoid this problem, all the images may be stored at high resolution. This, in turn, requires increased capacity to store the images.

### SUMMARY OF THE INVENTION

In view of the foregoing, the present invention is directed toward storing, if a part highlight image of a certain part of a model, such as an industrial product, clipped from an image of the entire model is small compared to the entire model image, the part highlight image at high resolution while minimizing the increase in the entire data volume, and thereby displaying the part highlight image with improved visibility.

In an embodiment of the present invention, there is provided a part identification image generation device that comprises a model management unit configured to manage a 3D model; a model region calculation unit configured to receive a viewpoint information item and an image size information item via an input/output device, project the shape of the 3D model onto a projection plane in a direction specified by the viewpoint information item to produce a projection image of the 3D model, and compute a model region information item about a region enclosing the projected shape of the 3D model with an aspect ratio specified by the image size information item; a part region calculation unit configured to project the shape of a part of the 3D model onto the projection plane in the direction specified by the viewpoint information item to produce a projection image of the part, and compute a part region information item about a region enclosing the projected shape of the part; an image data processing unit configured to clip an image of the 3D model from the projection image of the 3D model according to the model region information item to generate an entire model image according to the number of pixels specified by the image size information item, clip an image of the part from the projection image of the 3D model, in which the part is highlighted, according to the part region information item to generate a part highlight image according to the number of pixels calculated based on the image size information item, the model region information item, the part region information item, and a part resolution ratio, and compute a part positional information item indicating the position of the part highlight image relative to the entire model image based on the image size information item, the model region information item, and the part region information item; a part resolution ratio calculation unit configured to calculate the part resolution ratio; and an image data management unit configured to manage the entire model image, the part highlight image, the part positional information item, and the part resolution ratio as part catalog image data.

In another embodiment of the present invention, there is provided a part identification image display device that displays the entire model image with the part highlight image generated by the above-described part identification image generation device. The part identification image display device comprises a data reading unit configured to read the entire model image, the part highlight image, the part positional information item, and the part resolution ratio stored in a table data structure as the part catalog image data from the external input/output device; a display unit configured to display the entire model image on which the part highlight image is superposed according to the part positional information item; and an enlargement/reduction unit configured to, when displaying the entire model image on which the part highlight image is superposed, reduce the part highlight image according to the part resolution ratio and, if a display magnification is specified, reduce or enlarge the part highlight image according to the part resolution ratio and the display magnification.

In a further embodiment of the present invention, there is provided a part identification image generation method that comprises a model region calculating step of projecting the shape of a the 3D model onto a projection plane in a direction specified by a viewpoint information item to produce a projection image of the 3D model and computing a model region information item about a region enclosing the projected shape of the 3D model with an aspect ratio specified by an image size information item; a part region calculating step of projecting the shape of a part of the 3D model onto the projection plane in the direction specified by the viewpoint information item to produce a projection image of the part and computing a part region information item about a region enclosing the projected shape of the part; an image data processing step of clipping an image of the 3D model from the projection image of the 3D model according to the model region information item to generate an entire model image according to the number of pixels specified by the image size information item, clipping an image of the part from the projection image of the 3D model, in which the part is highlighted, according to the part region information item to generate a part highlight image according to the number of pixels calculated based on the image size information item, the model region information item, the part region information item, and a part resolution ratio, and computing a part positional information item indicating the position of the part highlight image relative to the entire model image based on the image size information item, the model region information item, and the part region information item; a part resolution ratio calculating step of calculating the part resolution ratio; and an image data managing step of managing the entire model image, the part highlight image, the part positional information item, and the part resolution ratio as part catalog image data.

According to still another embodiment of the present invention, there is provided a part identification image display method of displaying the entire model image with the part highlight image generated by the above-described part identification image generation method. The part identification image display method comprises a data reading step of reading the entire model image, the part highlight image, the part positional information item, and the part resolution ratio stored in a table data structure as the part catalog image data from the external input/output device; a displaying step of displaying the entire model image on which the part highlight image is superposed according to the part positional information item; and an enlarging/reducing step of, when displaying the entire model image on which the part highlight image is superposed, reducing the part highlight image according to the part resolution ratio and, if a display magnification is specified, reducing or enlarging the part highlight image according to the part resolution ratio and the display magnification.

According to still another aspect of the present invention, there is provided a computer-readable recording medium storing a program that includes computer-executable instructions for executing the above-described part identification image generation method.

According to still another aspect of the present invention, there is provided a computer-readable recording medium storing a program that includes computer-executable instructions for executing the above-described part identification image display method.

According to an aspect of the present invention, it is possible to generate a part highlight image at increased resolution while minimizing the increase in the entire data volume. Furthermore, it is possible to superpose the part highlight image stored at high resolution on the entire model image and clearly display the part highlight image at high resolution when enlarging the part highlight image superposed on the entire model image.

### BRIEF DESCRIPTION OF THE DRAWINGS

FIG. 1 is a block diagram schematically illustrating the configuration of a part identification image generation device according to an embodiment of the present invention;

FIG. 2 is a block diagram showing an exemplary software configuration of a part catalog image data generation system of the part identification image generation device;

FIG. 3 is a schematic diagram illustrating a viewpoint information item;

FIG. 4 is a schematic diagram illustrating projection of a 3D model;

FIG. 5 is a flowchart illustrating an exemplary process of calculating a combination of the smallest X and Y coordinates and a combination of the greatest X and Y coordinates;

FIG. 6 is a schematic diagram illustrating a part positional information item;

FIG. 7 is a schematic diagram illustrating exemplary part catalog image data;

FIG. 8A is a diagram illustrating an entire model image;

FIG. 8B is a diagram illustrating a part highlight image;

FIG. 8C is a diagram illustrating an entire model image with a part highlight image superposed thereon;

FIG. 9 is a diagram illustrating an enlarged entire model image and part highlight image;

FIG. 10 is a flowchart illustrating a part catalog image generation process; and

FIG. 11 is a flowchart illustrating a part catalog image display process.

### DETAILED DESCRIPTION OF THE PREFERRED EMBODIMENT

Exemplary embodiments of the present invention are described below with reference to the accompanying drawings.

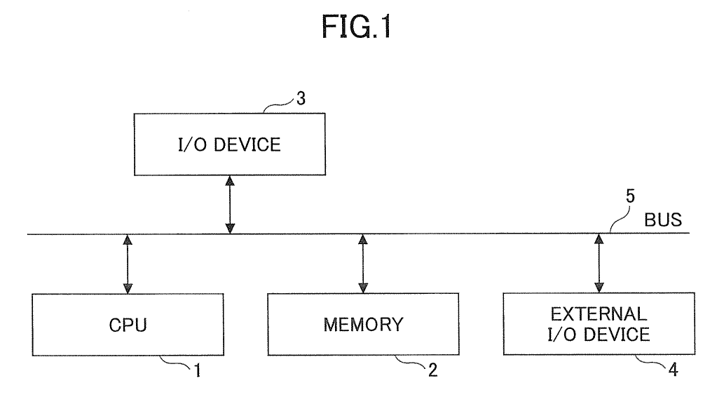

FIG. 1 is a block diagram schematically illustrating the configuration of a part identification image generation device according to an embodiment of the present invention.

In FIG. 1, the part identification image generation device includes a CPU (central processing unit) 1 configured to perform various data processing operations, a memory 2 used as a work area for the CPU 1 and configured to store data of various programs, an input/output device (I/O device) 3 configured to input data to and output data from the part identification image generation device according to user's operations, and an external input/output device (external I/O device) 4 configured to input data from and output data to an external device.

The CPU 1, the memory 2, the input/output device 3, and the external input/output device 4 are connected via a bus 5 and exchange various data items among them via the bus 5.

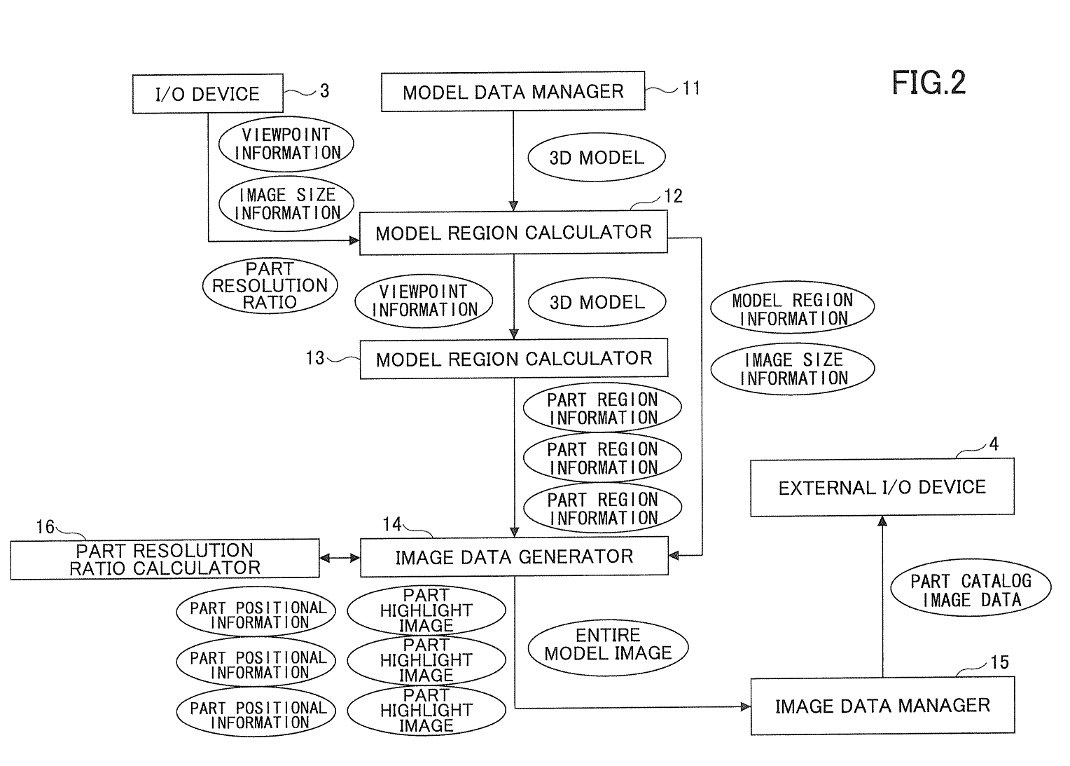

FIG. 2 is a block diagram showing an exemplary software configuration of a part catalog image data generation system of the part identification image generation device.

The part catalog image data generation system includes a model data manager 11, a model region calculator 12, a part region calculator 13, an image data generator 14, an image data manager 15, and a part resolution ratio calculator 16. The model data manager 11 is configured to manage a previously-prepared 3D model. The model region calculator 12 is configured to receive a viewpoint information item and an image size information item via the input/output device 3, project the shape of the 3D model onto a projection plane in a direction specified by the viewpoint information item to generate a 2D projection image of the 3D model, and compute a model region information item about a model region enclosing a 2D image of the projected shape of the 3D model with an aspect ratio specified by the image size information item. The part region calculator 13 is configured to project the shape of each part of the 3D model onto the projection plane in the direction specified by the viewpoint information item to generate a 2D projection image of the part, and compute a part region information item about a part region enclosing a 2D image of the projected shape of the part. The image data generator 14 is configured to clip an entire model image from the 2D projection image of the 3D model according to the model region information item, clip a part highlight image from the 2D projection image of the 3D model, in which the part is highlighted, and compute a part positional information item indicating the position of the part highlight image relative to the entire model image. The image data manager 15 is configured to manage the entire model image, the part highlight image, the part positional information item, and a part resolution ratio (described below) as part catalog image data. The part resolution ratio calculator 16 is configured to calculate the part resolution ratio γ defining a multiplication factor for the number of pixels of the part highlight image.

Operations of the part catalog image data generation system are described below.

(Step 1)

The model data manager 11 transmits data of the previously-prepared 3D model with plural parts mounted thereon to the model region calculator 12.

(Step 2)

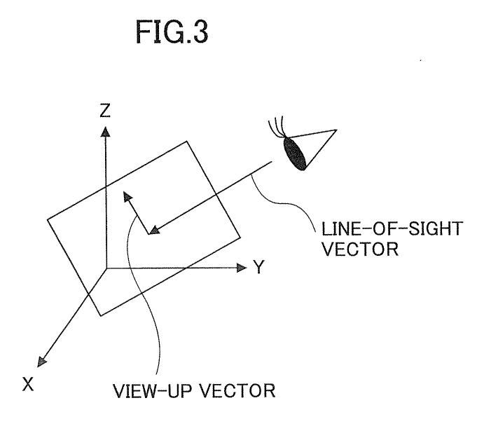

The model region calculator 12 receives a viewpoint information item and an image size information item from the input/output device 3. Referring to FIG. 3, the viewpoint information item includes two 3D vectors, namely, a line-of-sight vector and a view-up vector.

The line-of-sight vector indicates the direction of the line of sight in a 3D space and specifies the direction of parallel projection of the 3D model. The view-up vector indicates the upward direction with respect to the line of sight in the 3D space and forms a right angle with the line-of-sight vector.

That is, the view-up vector is parallel to the projection plane of the parallel projection. The image size information item includes the number of pixels (W) in the horizontal direction and the number of pixels (H) in the vertical direction.

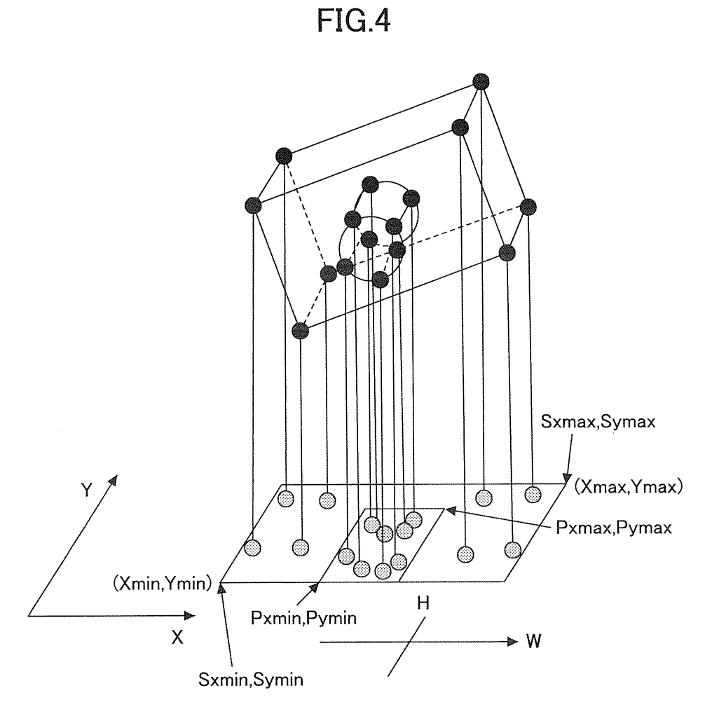

FIG. 4 shows the 3D model projected on the projection plane.

(Step 3)

The model region calculator 12 produces a parallel projection of the 3D model, of which data are transmitted from the model data manager 11, in the direction of the line-of-sight vector of the line-of-sight information item, computes a model region information item about a rectangular region containing the 3D model projected on the projection plane and having the same aspect ratio (W/H) as the aspect ratio (W/H) of the image size information item received from the input/output device 3, and transmits the computed model region information item to the image data generator 14.

The rectangular region of the model is calculated as described below. Here, the projection plane is represented by an X-Y rectangular coordinate system in which the view-up vector defines a Y-axis direction.

(1) All the points defining the shape of the 3D model are projected onto the projection plane, and the X and Y coordinates of the points are calculated (see FIG. 4).

(2) A combination of the smallest X and Y coordinates (Xmin, Ymin) and a combination of the greatest X and Y coordinates (Xmax, Ymax) are calculated from the X and Y coordinates calculated in (1).

(3) The smallest coordinates (Sxmin, Symin) and the greatest coordinates (Sxmax, Symax) of the rectangular region of the 3D model are calculated. Here, α (=the number of pixels (W) in the horizontal direction/the number of pixels (H) in the vertical direction) represents the aspect ratio of the image size. The calculated smallest coordinates (Sxmin, Symin) and the greatest coordinates (Sxmax, Symax) are defined as the model region information item.

(i) If Xmax−Xmin≧Ymax−Ymin, then

Sxmin=Xmin

Symin=(Ymax−Ymin)/2−α(Xmax−Xmin)/2

Symax=(Ymax−Ymin)/2+α(Xmax−Xmin)/2 (I)

(ii) If Xmax−Xmin<Ymax−Ymin, then

Sxmin=(Xmax−Xmin)/2−(Ymax−Ymin)/(2α)

Sxmax=(Xmax−Xmin)/2+(Ymax−Ymin)/(2α) (II)

Symin=Ymin

Symax=Ymax

FIG. 5 is a flowchart illustrating a process of calculating a combination of the smallest coordinates and a combination of the greatest coordinates of the model in (2).

First, one of the points defining the model is projected onto the projection plane in the direction of the line-of-sight vector of the viewpoint information item (S101). Then, it is determined whether the x coordinate is the greatest or smallest among x coordinates of previously projected points (S102). If the determination is negative (NO in S102), then it is determined whether the y coordinate is the greatest or smallest among y coordinates of previously projected points (S104). If the determination is negative (NO in S104), then it is determined whether there is any point that is not projected (S106). If the determination is affirmative (YES in S106), the process returns to Step S101.

If the determination in Step S102 is affirmative (YES in S102), the x coordinate is stored as Xmax or Xmin (S103), and the process proceeds to Step S104. If the determination in Step S104 is affirmative (YES in Step S104), the y coordinate is stored as Ymax or Ymin (S105), and the process proceeds to Step S106. If all the points are projected (NO in S106), the process ends.

(Step 4)

The model region calculator 12 transmits the data of the 3D model and the view information item to the part region calculator 13. The model region calculator 12 also transmits the image size information item to the image data generator 14.

(Step 5)

The part region calculator 13 produces a parallel projection of each part of the 3D model in the direction of the line-of-sight vector of the line-of-sight information item, computes a part region information item about the smallest rectangular region containing the part projected on the projection plane, and transmits the computed part region information item to the image data generator 14.

The smallest rectangular region containing the projected image of the part is calculated as described below. Here, the projection plane is represented by the same X-Y rectangular coordinate system as the X-Y rectangular coordinate system of Step 3.

(1) All the points defining the shape of the part are projected onto the projection plane, and the X and Y coordinates of the points are calculated.

(2) A combination of the smallest X and Y coordinates (Pxmin, Pymin) and a combination of the greatest X and Y coordinates (Pxmax, Pymax) of the part are calculated from the X and Y coordinates calculated in (1). The obtained smallest coordinates and the greatest coordinates are determined as the smallest coordinates and the greatest coordinates of the rectangular region of the part, which are defined as the part region information item.

(Step 6)

In addition to the part region information item about the smallest rectangular region containing the projected image of the part transmitted to the image data generator 14 in Step 5, the part region calculator 13 also transmits the data of each part of the 3D model and the viewpoint information item received in Step 4 to the image data generator 14.

(Step 7)

The image data generator 14 clips the rectangular region containing the 3D model from the parallel projection image of the 3D model based on the model region information item to generate image data (an entire model image) according to the number of pixels specified by the image size information item, and transmits the entire model image to the image data manager 15.

(Step 8)

The image data generator 14 clips the smallest rectangular region containing each part of the 3D model from the parallel projection image of the 3D model, in which the corresponding part is highlighted, based on the corresponding part region information item to generate image data (a part highlight image) according to the number of pixels in the horizontal direction and the number of pixels in the vertical direction calculated using the following expressions based on the image size information item, the model region information item, the part region information item, and the part resolution ratio γ. The part resolution ratio γ is received from the part resolution ratio calculator 16. The image data generator 14 transmits the part highlight image to the image data manager 15.

the number of pixels in the horizontal direction

γ[(Pxmax−Pxmin)/{(Sxmax−Sxmin)/W}]

the number of pixels in the vertical direction

γ[(Pymax−Pymin)/{(Symax−Symin)/H}] (III)

The part resolution ratio γ may be calculated using the following expression, for example.

γ=β×√[{(Sxmax−Sxmin)×(Symax−Symin)}/{(Pxmax−Pxmin)×(Pymax−Pymin)}] (IV)

Here, if γ<1, then γ=1 is applied.

That is, γ is calculated by multiplying the square root of the ratio of the area of the rectangular region of the model to the area of the rectangular region of the part (the area of the rectangular region of the model/the area of the rectangular region of the part) by β.

Here, β is a constant value given by the input/output device 3. When the value of β is specified in the range of 0<β<1, the data volume of the part highlight image and the resolution can be balanced.

If the ratio of the area of the rectangular region of the model to the area rectangular region of the part is 16:1, then the square root of the ratio is 4. Here, if β=1/2 is given by the input/output device 3, then the part resolution ratio γ=2. Accordingly, the number of pixels of the part highlight image is doubled, so that the resolution of the part highlight image is increased.

The greater the ratio of the area of the rectangular region of the model to the rectangular region of the part, i.e., the smaller the area of the part highlight image compared to the area of the entire model image, the greater the value γ, so that the number of pixels of the part highlight image is increased to improve the resolution.

If the ratio of the area of the rectangular region of the model and the rectangular region of the part is 64:1, then the square root of the ratio is 8. Here, if β=1/2, then the part resolution ratio γ=4. Accordingly, the number of pixels of the part highlight image is quadrupled, so that the resolution of the part highlight image is increased.

(Step 9)

The image data generator 14 determines the position of the part highlight image of each part relative to the entire model image and transmits information about the position (part positional information item) to the image data manager 15.

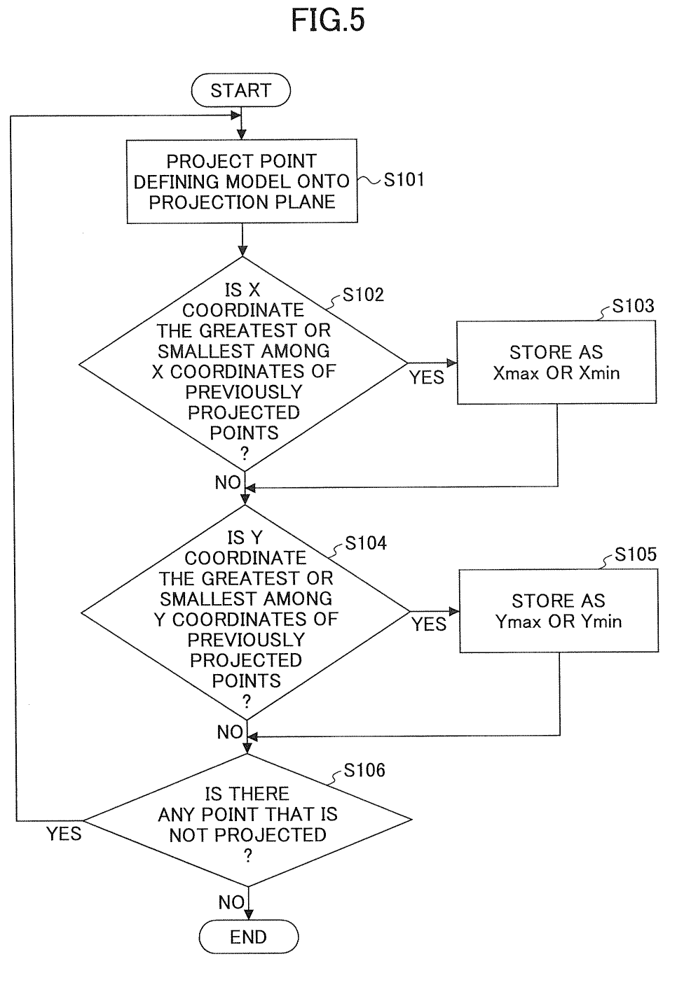

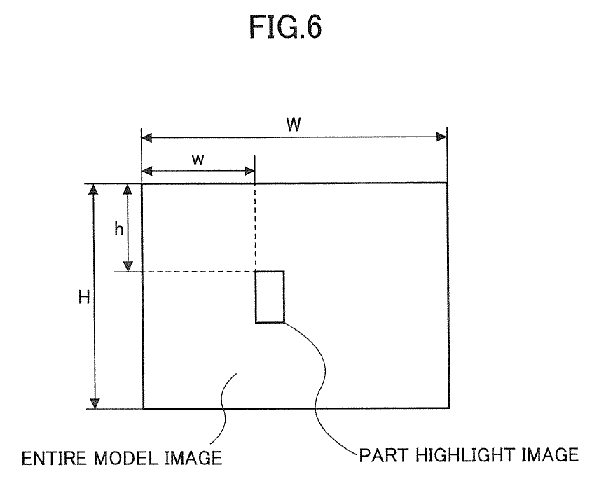

The part positional information item includes, for example, the position of the upper left corner of the part highlight image relative to the upper left corner of the entire model image, i.e., the number of pixels w in the horizontal direction and the number of pixels h in the vertical direction from the upper left corner of the entire model image to the upper left corner of the part highlight image. Here, w and h of each part are calculated as follows (see FIG. 6).

w=[W(Pxmin−Sxmin)/Sxmax−Sxmin]

h=[H(Symax−Pymax)/Symax−Symin] (V)

(Step 10)

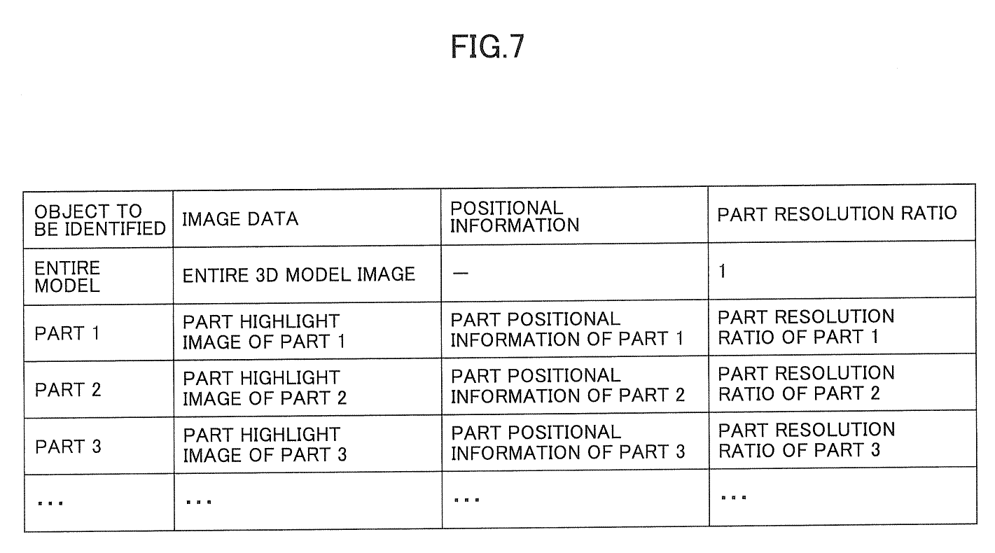

The image data manager 15 outputs the entire model image, the part highlight images, the part positional information items, and the part resolution ratios γ to the external input/output device 4 in a table data structure as shown in FIG. 7 and thus stores and manages these information items as the part catalog image data.

A part identification image display device and a part identification image display method for displaying the entire model image and the part highlight image generated by the part identification image generation device are described below.

The part identification image display device includes the CPU 1 and a well-known display unit (not shown), such as an LCD (liquid crystal display) provided in the input/output device 3. The CPU 1 reads the entire model image, the part highlight images, the part positional information items, and the part resolution ratios γ stored in the table data structure as the part catalog image data from the external input/output device 4. When displaying the read entire model image with the read part highlight image superposed thereon, the CPU 1 functions as a part highlight image enlargement/reduction configured to reduce the part highlight image according to the part resolution ratio and, if a display magnification is specified in the input/output device 3, enlarges or reduces the part highlight image according to the part resolution ratio and the display magnification.

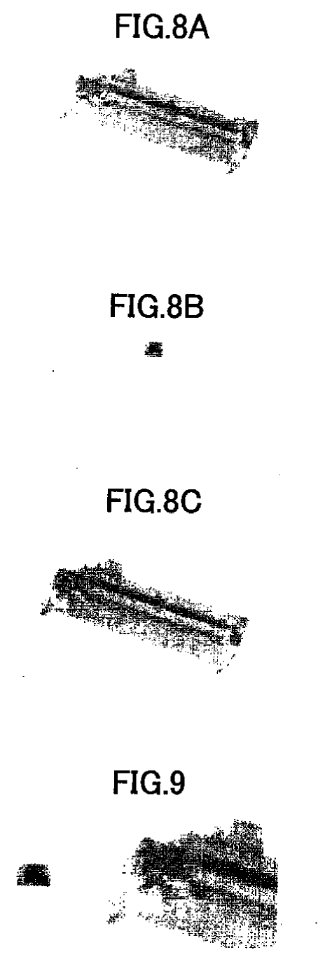

FIG. 8A shows the entire model image. FIG. 8B shows the part highlight image in which the part is highlighted in a deep color (red, for example). FIG. 8C shows the entire model image with the part highlight image superposed thereon.

FIG. 9 shows the enlarged entire model image and part highlight image. The entire model image is grainy. On the other hand, since the number of pixels of the part highlight image is multiplied by γ, the part highlight image is displayed more clearly than the entire model image. That is, since the part highlight image is stored at high resolution, the part highlight image can be displayed with higher image quality than the other area when enlarged.

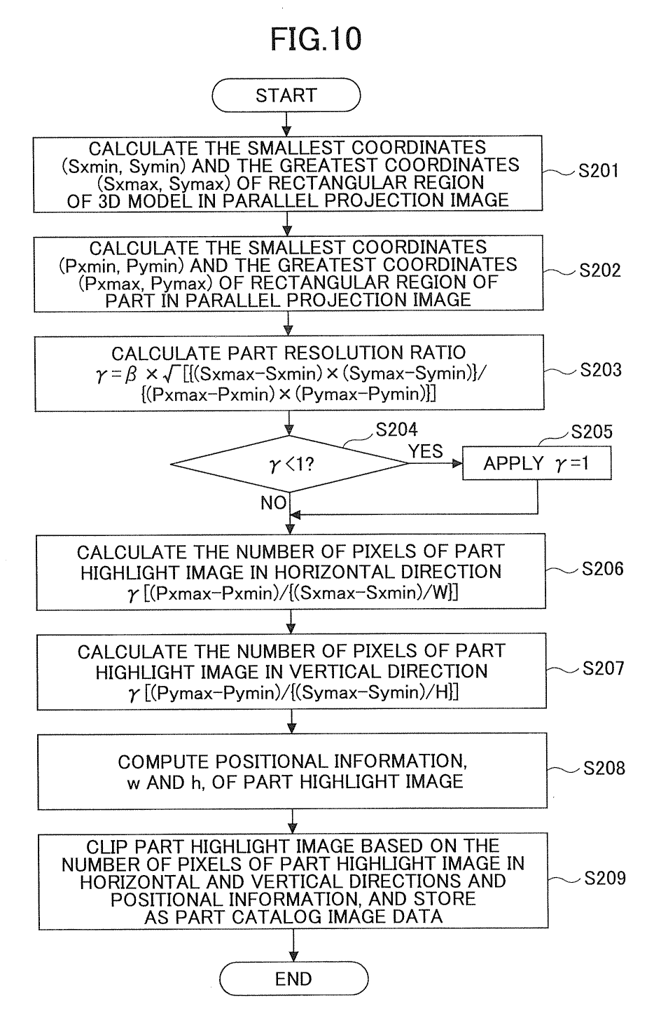

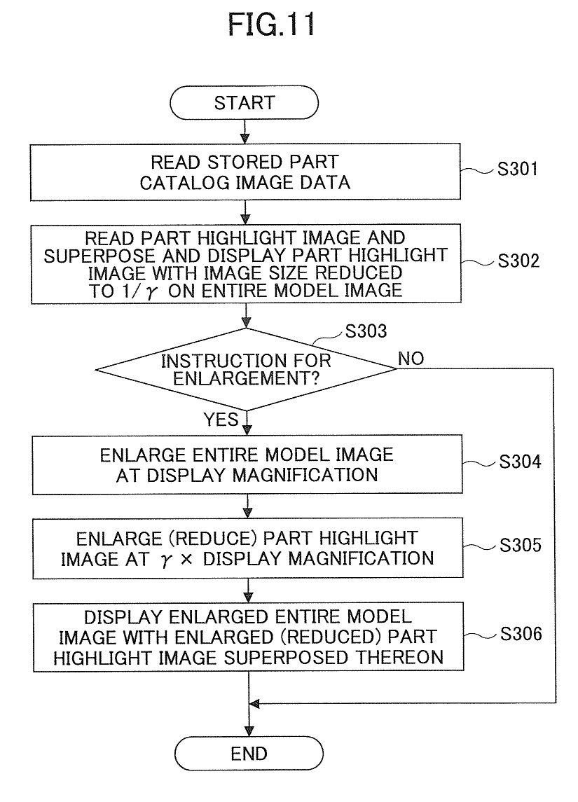

FIG. 10 is a flowchart illustrating a part catalog image generation process. FIG. 11 is a flowchart illustrating a part catalog image display process.

The part catalog image generation process is described with reference to FIG. 10. First, the smallest coordinates and the greatest coordinates of the rectangular region of the 3D model in the parallel projection image of the 3D model in the direction of the line-of-sight vector of the line-of-sight information item received in Step 2 are calculated (S201). Then, the smallest coordinates and the greatest coordinates of the rectangular region of the part are calculated (S202).

Next, the part resolution ratio γ is calculated using the information of the rectangular regions of the 3D model and the part (the model region information item and the part region information item) and β given by the input/output device 3 (S203). If γ is less than 1 (YES in S204), then 1 is specified as γ (S205). On the other hand, if γ is 1 or greater (NO in S204), no change is made to the value of γ. Then, the number of pixels of the part highlight image in the horizontal direction and the vertical direction are calculated (S206, S207).

Subsequently, the positional information item, w and h, of the part highlight image is computed (S208). Then the part highlight image is clipped based on the number of pixels of the part highlight image in the horizontal and vertical directions and the part positional information item, and the clipped part highlight image is stored as part catalog image data (S209). Thus the process ends.

The part catalog image display process is described below with reference to FIG. 11. First, the part catalog image data stored in the external input/output device 4 are read (S301). The part highlight image is read, is superposed with the image size reduced to 1/γ (part resolution ratio) on the entire model image, and is displayed (S302). If there is no instruction for enlargement (NO in S303), the process ends. On the other hand, if there is an instruction for enlargement (YES in S303), the entire model image is enlarged at the specified display magnification (S304) and the part highlight image is enlarged (reduced) at γ× the specified display magnification (S305). The enlarged entire model image with the enlarged (reduced) part highlight image superposed thereon is displayed (S306). Thus the process ends.

The part catalog image generation process, the part catalog image display process, and functions used in theses processes may be executed by computer-executable programs. These programs may be stored in well-known computer-readable media such as flexible disks, magnetic disks, and magneto optical disks (MOs).

According to the above-described embodiments of the present invention, the part resolution ratio calculator calculates the part resolution ratio γ. The resolution of the part highlight image is increased based on the calculated part resolution ratio γ, so that the part highlight image with improved visibility can be generated.

The value of β may be specified in a way that balances the part highlight image and the entire model image. Thus, the number of pixels of the part highlight image is increased to improve the resolution and the visibility of the part highlight image while minimizing the increase in the entire data volume.

The entire model image, the part highlight images, the part positional information items, and the part resolution ratios γ are output to the external input/output device 4 in a table data structure, and are stored and managed as part catalog image data. Therefore, compared to the case where an image for identifying a part is stored with the same image size as the image size of the entire model image, the required capacity of the external input/output device can be reduced.

The stored part catalog image data contain the part resolution ratio. Therefore, when displaying the entire model image with the part highlight image superposed thereon, it is possible to superpose the part highlight image with the size that matches the entire model image.

That is, when superposing the part highlight image on the entire model image according to the corresponding part positional information item, since the number of pixels of the part highlight image is multiplied by the part resolution ratio γ, the part highlight image is reduced by the part resolution ratio γ. Thus, it is possible to display the model with the part mounted thereon in a natural state and allows identifying the part in the displayed image.

In the case of displaying an enlarged image of the model with the part mounted thereon, the entire model image is enlarged, and the part highlight image is enlarged and superposed on the enlarge entire model image. In this case, the enlarged entire model image is rough. On the other hand, since the resolution of the part highlight image is stored at higher resolution than the resolution of the entire model image, the enlarged part highlight image superposed on the enlarged entire model image is not as rough as the enlarged entire model image.

The above-described embodiments of the part identification image generation device, the part identification image generation method, the part identification image display device, and the part identification image display method may be embodied as units of the above-described device including the CPU and may be executed by programs including instructions for executing the methods.

These programs may be stored in well-known computer-readable media.

The present application is based on Japanese Priority Application No. 2007-291644 filed on Nov. 9, 2007, with the Japanese Patent Office, the entire contents of which are hereby incorporated herein by reference.

What is claimed is:

1. A part identification image generation device, comprising:
a model management unit configured to manage a 3D model;
a model region calculation unit configured to receive a viewpoint information item and an image size information item via an input/output device, project a shape of the 3D model onto a projection plane in a direction specified by the viewpoint information item to produce a projection image of the 3D model, and compute a model region information item about a region enclosing the projected shape of the 3D model with an aspect ratio specified by the image size information item;
a part region calculation unit configured to project a shape of a part of the 3D model onto the projection plane in the direction specified by the viewpoint information item to produce a projection image of the part, and compute a part region information item about a region enclosing the projected shape of the part;
an image data processing unit configured to clip an image of the 3D model from the projection image of the 3D model according to the model region information item to generate an entire model image according to the number of pixels specified by the image size information item, clip an image of the part from the projection image of the 3D model, in which the part is highlighted, according to the part region information item to generate a part highlight image according to the number of pixels calculated based on the image size information item, the model region information item, the part region information item, and a part resolution ratio, and compute a part positional information item indicating a position of the part highlight image relative to the entire model image based on the image size information item, the model region information item, and the part region information item;
a part resolution ratio calculation unit configured to calculate the part resolution ratio; and
an image data management unit configured to manage the entire model image, the part highlight image, the part positional information item, and the part resolution ratio as part catalog image data.

2. The part identification image generation device as claimed in claim 1, wherein the part region calculation unit projects points defining the shape of the part onto the projection plane represented by an X-Y rectangular coordinate system, calculates the smallest X and Y coordinates and the greatest X and Y coordinates of the part, determines a rectangular region defined by the smallest X and Y coordinates and the greatest X and Y coordinates, and defines the rectangular region as the part region information item.

3. The part identification image generation device as claimed in claim 1, wherein the part resolution ratio calculation unit calculates the part resolution ratio based on the model region information item and the part region information item.

4. The part identification image generation device as claimed in claim 1, wherein the image data management unit outputs the entire model image, the part highlight image, the part positional information item, and the part resolution ratio to an external input/output device in a table data structure and stores and manages the entire model image, the part highlight image, the part positional information item, and the part resolution ratio as the part catalog image data.

5. A part identification image display device that displays the entire model image with the part highlight image generated by the part identification image generation device of claim 1, the part identification image display device comprising:
a data reading unit configured to read the entire model image, the part highlight image, the part positional information item, and the part resolution ratio stored in a table data structure as the part catalog image data from the external input/output device;
a display unit configured to display the entire model image on which the part highlight image is superposed according to the part positional information item; and
an enlargement/reduction unit configured to, when displaying the entire model image on which the part highlight image is superposed, reduce the part highlight image according to the part resolution ratio and, if a display magnification is specified, reduce or enlarge the part highlight image according to the part resolution ratio and the display magnification.

6. A part identification image generation method, comprising:
a model region calculating step of projecting a shape of a the 3D model onto a projection plane in a direction specified by a viewpoint information item to produce a projection image of the 3D model and computing a model region information item about a region enclosing the projected shape of the 3D model with an aspect ratio specified by an image size information item;
a part region calculating step of projecting a shape of a part of the 3D model onto the projection plane in the direction specified by the viewpoint information item to produce a projection image of the part and computing a part region information item about a region enclosing the projected shape of the part;
an image data processing step of clipping an image of the 3D model from the projection image of the 3D model according to the model region information item to generate an entire model image according to the number of pixels specified by the image size information item, clipping an image of the part from the projection image of the 3D model, in which the part is highlighted, according to the part region information item to generate a part highlight image according to the number of pixels calculated based on the image size information item, the model region information item, the part region information item, and a part resolution ratio, and computing a part positional information item indicating a position of the part highlight image relative to the entire model image based on the image size information item, the model region information item, and the part region information item;
a part resolution ratio calculating step of calculating the part resolution ratio; and
an image data managing step of managing the entire model image, the part highlight image, the part positional information item, and the part resolution ratio as part catalog image data.

7. The part identification image generation method as claimed in claim 6, wherein, in the part region calculating step, points defining the shape of the part are projected onto the projection plane represented by an X-Y rectangular coordinate system; the smallest X and Y coordinates and the greatest X and Y coordinates of the part are calculated; a rectangular region defined by the smallest X and Y coordinates and the greatest X and Y coordinates is determined; and the rectangular region is defined as the part region information item.

8. The part identification image generation method as claimed in claim 6, wherein, in the part resolution ratio calculating step, the part resolution ratio is calculated based on the model region information item and the part region information item.

9. The part identification image generation method as claimed in claim 6, wherein, in the image data managing step, the entire model image, the part highlight image, the part positional information item, and the part resolution ratio are output to an external input/output device in a table data structure, and the entire model image, the part highlight image, the part positional information item, and the part resolution ratio are stored and managed as the part catalog image data.

10. A part identification image display method of displaying the entire model image with the part highlight image generated by the part identification image generation method of claim 6, the part identification image display method comprising:
a data reading step of reading the entire model image, the part highlight image, the part positional information item, and the part resolution ratio stored in a table data structure as the part catalog image data from the external input/output device;
a displaying step of displaying the entire model image on which the part highlight image is superposed according to the part positional information item; and
an enlarging/reducing step of, when displaying the entire model image on which the part highlight image is superposed, reducing the part highlight image according to the part resolution ratio and, if a display magnification is specified, reducing or enlarging the part highlight image according to the part resolution ratio and the display magnification.

11. A computer-readable recording medium storing a program, the program including computer-executable instructions for executing the part identification image generation method of claim 6.

12. A computer-readable recording medium storing a program, the program including computer-executable instructions for executing the part identification image display method of claim 10.
